(19) United States
(12) Patent Application Publication
(10) Pub. No.: US 2016/0070070 A1
(43) Pub. Date: Mar. 10, 2016

(54) INTEGRATED TORQUE ASSEMBLY AND METHODS FOR OCT USING AN OPTICAL FIBER CABLE

(71) Applicant: Corning Incorporated, Corning, NY (US)

(72) Inventor: Venkata Adiseshaiah Bhagavatula, Big Flats, NY (US)

(21) Appl. No.: 14/848,468

(22) Filed: Sep. 9, 2015

Related U.S. Application Data
(60) Provisional application No. 62/047,947, filed on Sep. 9, 2014.

(51) Int. Cl. G02B 6/36; G01B 9/02

(52) U.S. Cl. CPC G02B 6/3604; G01B 9/02091

(57) ABSTRACT

An integrated torque assembly for optical coherence tomography includes an optical fiber cable having an optical fiber surrounded by an outer jacket. An optical probe is operably attached to the distal end of the optical fiber cable. The outer jacket includes outwardly extending protrusions. The optical fiber cable and optical probe are operably disposed within an interior of a guide tube having an inner surface. The protrusions reduce the amount of surface area the optical fiber cable presents to the guide tube inner surface and thus reduces friction during operation.

### CROSS-REFERENCE To RELATED APPLICATIONS

This application claims the benefit of priority under 35 U.S.C. §119 of U.S. Provisional Application Ser. No. 62/047,947 filed on Sep. 9, 2014, the content of which is relied upon and incorporated herein by reference in its entirety.

### FIELD

The present disclosure relates to optical coherence tomography (OCT), and in particular relates to an integrated torque assembly for OCT that uses an optical fiber cable, and related methods.

The entire disclosure of any publication or patent document mentioned herein is incorporated by reference, including U.S. Patent Application Publication No. 2013/0223787 and the article entitled “Optical coherence tomography,” by Huang, et al., Science 254, New Series, no. 5035 (Nov. 22, 1991): 1178-1181.

### BACKGROUND

Optical coherence tomography (OCT) is used to capture a high-resolution cross-sectional image of scattering biological tissues using fiber-optic interferometry. The core of an OCT system is a Michelson interferometer, wherein a first optical fiber is used as a reference arm and a second optical fiber is used as a sample arm. The sample arm includes the sample to be analyzed as well as an optical probe that includes optical components. An upstream light source provides the imaging light, which has an OCT imaging wavelength. A photodetector is arranged in the optical path downstream of the sample and reference arms.

Optical interference of light the sample arm and the reference arm is detected by the photodetector only when the optical path difference between the two arms is within the coherence length of the light from the light source. Depth information from the sample is acquired by axially varying the optical-path length of the reference arm and detecting the interference between light from the reference arm and scattered light from the sample arm that originates from within the sample.

A three-dimensional image requires high-speed rotation as well as axial translation of the optical probe. This rotation and axial translation is carried out in conventional OCT systems through the use of a metal torque tube that is mechanically connected to the probe at a distal end, The torque tube is threaded through a guide tube, which is referred to in the art as an “inner lumen.” The torque tube is driven to rotate and axially translate at its proximal end by a rotary and axial translation actuator and transmits the rotational and axial translation motion to the optical probe at the distal end.

Conventional torque tubes are made of stainless steel and have a multi-coil spring assembly, which is a relatively complex design and does not offer very good dimensional control, Further, the torque tube must be feed into the inner lumen over long distances, which is difficult to do because of the flexibility of the spring coil. In addition, a large amount of surface-area contact can occur between the torque tube and the inner lumen. This surface-area contact is a source of friction that impacts the rotation and axial translation of the optical probe.

It is therefore desirable to simplify the mechanism used to impart rotation to the optical probe so that the OCT system is less expensive and easier to use while the potential contact area and frictional forces that can adversely impact performance are also reduced.

### SUMMARY

Integrated torque assemblies and methods for optical coherence tomography are disclosed. The integrated torque assembly includes an optical-fiber cable having an optical fiber surrounded by an outer jacket. An optical probe is operably attached to a distal end of the optical-fiber cable. The outer jacket has a main body with a plurality of outwardly extending protrusions. The optical-fiber cable and optical probe are optically disposed within an interior of a guide tube in a close-fit configuration to form the assembly. The protrusions serve to reduce the amount of surface area the optical fiber cable presents to an inner surface of the guide tube as compared to an optical fiber cable having a circular cross-section. This serves to reduce the amount of friction between the optical fiber cable and guide tube during rotation and translation of the optical fiber cable when OCT imaging is performed. The systems and methods disclosed herein can be used generally for OCT, e.g., for time-domain or frequency-domain OCT.

An aspect of the disclosure is an integrated torque assembly for use with a guide tube of an OCT system that utilizes a rotating optical probe. The assembly includes: a flexible guide tube having an inside surface that defines a guide tube inner diameter and a guide tube interior, with at least a portion of the guide tube being transparent to light at an OCT imaging wavelength; an optical fiber cable having an optical fiber surrounded by a jacket and having a length, the optical fiber cable having a proximal end and a distal end, wherein the jacket has a plurality of outwardly extending protrusions; an optical probe operably connected to the distal end of the optical fiber cable; and wherein the optical fiber cable and optical probe are operably disposed within the guide-tube interior in a close-fit configuration wherein the optical fiber cable can rotate and be axially translated within the interior of the flexible guide tube while the optical fiber cable only contacts the inner surface of the guide tube at the protrusions of the jacket.

Another aspect of the disclosure is an OCT assembly that includes the integrated torque assembly described immediately above, and a rotary and axial translation actuator operably attached to the proximal end of the optical fiber cable.

Another aspect of the disclosure is an integrated torque assembly for use with a guide tube of an OCT system that utilizes a rotating optical probe. The assembly includes: a flexible and transparent guide tube having an inside surface that defines a guide-tube inner diameter and a guide-tube interior; an optical fiber cable having an optical fiber having a proximal end and a distal end, and having a jacket that includes a main body and a plurality of protrusions that outwardly extend from the main body, with the protrusions and the inner surface of the guide tube defining a contact-area ratio RC 50%; an optical probe operably connected to the distal end of the optical fiber cable. The optical fiber cable and optical probe are operably disposed within the guide-tube interior in a close-fit configuration such that the optical fiber cable can rotate and be axially translated within the interior of the flexible guide tube.

Another aspect of the disclosure is an OCT assembly that includes the integrated torque assembly described immediately above, and a rotary and axial translation actuator operably attached to the proximal end of the optical fiber cable.

Another aspect of the disclosure is a method of rotating and axially translating an optical probe in an OCT system. The method includes: operably connecting an optical probe to a distal end of an optical fiber cable having a proximal end and an outer jacket with a main body and a plurality of outwardly extending protrusions each having an outermost portion; inserting the optical fiber cable and probe into an interior of a flexible guide tube having an inner surface to define a close-fit configuration between the optical fiber cable and the guide tube; and causing a rotation and an axial translation of the optical fiber cable at the proximal end so that the optical fiber cable and optical probe rotate and axially translate within the interior of the flexible guide tube while the optical fiber cable only contacts the inner surface of the guide tube at the outermost portions of the protrusions of the jacket.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the Detailed Description serve to explain principles and operation of the various embodiments. As such, the disclosure will become more fully understood from the following Detailed Description, taken in conjunction with the accompanying Figures, in which:

FIG. 1 is a cross-sectional view of the probe-end portion of an example prior-art OCT system;

FIG. 2A is a partially exploded side view of a first example embodiment of an example OCT system according to the disclosure that includes an example integrated torque assembly;

FIG. 2B is a close-up cross-sectional view of an example optical-fiber cable of the integrated torque assembly of FIG. 2A;

FIGS. 3A through 3L are cross-sectional views of the cable jacket (“jacket”) of the optical-fiber cable of the integrated torque assembly of FIG. 2A as taken in the direction indicated by the arrows A-A in FIG. 2B, showing different example embodiments of cross-sectional shapes that present a reduced surface area to the guide-tube inner surface as compared to a jacket having a circular cross-section;

FIG. 4 is similar to FIG. 2A and shows the assembled OCT system with the cable operably disposed within the guide-tube interior in the close-fit configuration to form the integrated torque assembly;

FIG. 5A is a close-up front-elevated cut-away view of the integrated torque assembly of FIG. 4, wherein the optical fiber cable is shown as having the cross-sectional shape of FIG. 3B by way of example;

FIG. 5B is a front-on view of the integrated torque assembly of FIG. 5A;

FIG. 6 is cross-sectional view of an example optical fiber cable wherein the jacket has the cross-sectional shape of FIG. 3B and wherein the jacket outer surface includes a low-friction coating;

FIG. 7 is a cross-sectional view of an example integrated torque assembly wherein the jacket of the optical fiber cable has a triangular cross-sectional shape by way of example, and wherein the guide tube and outermost portions of the protrusions include a low-friction coating to facilitate the rotation and axial translation of the optical fiber cable within the guide tube;

FIG. 8A is photograph of TexMatte material with PMMA particles having a size in the range from 25 μm to 30 μm;

FIG. 8B is a plot of the frictional force FF (grams, g) versus distance D (relative units, r.u.) for three different sets of measurements of the measured frictional force for white ink as a control material; and

FIG. 8C is the same plot as FIG. 8B but based on data of the measured frictional force FF for the white ink material coated with TexMatte 6025 beads and a 20% F-acrylate low-friction additive, wherein the plot represents an average of three sets of measurements and shows a substantial reduction in the frictional force FF as compared to that of the control.

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure.

The claims as set forth below are incorporated into and constitute a part of this Detailed Description.

The entire disclosure of any publication or patent document mentioned herein is incorporated by reference.

### OCT System

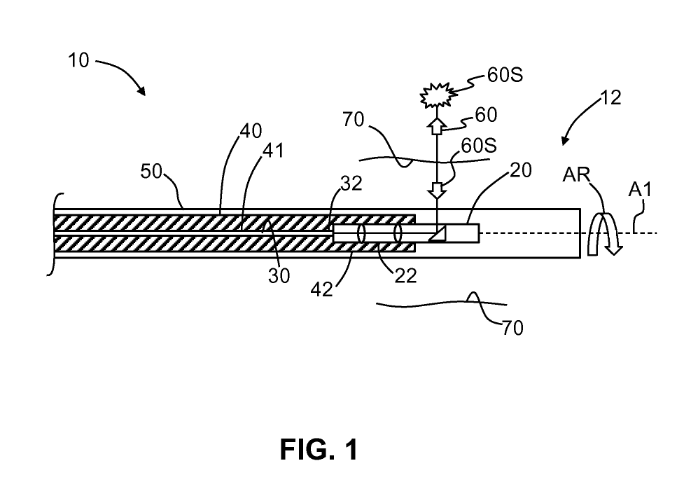

FIG. 1 is a cross-sectional view of an example prior-art OCT system 10 showing a probe-end portion 12. The OCT system 10 includes an optical probe (“probe”) 20 that is operably connected to an end 32 of an optical fiber 30. At least a portion of probe 20 is transparent. The optical fiber 30 is supported within a channel 41 of a metal (e.g., stainless steel) torque tube 40. It is noted here that optical fiber 30 and torque tube 40 are separate components that need to be formed separately and then mechanically combined so that the optical fiber is secured within channel 41 of the torque tube. The torque tube 40 is a multi-coil spring assembly made of a metal such as stainless steel.

An end portion 22 of probe 20 is attached to an end portion 42 of torque tube 40. In an example, end portion 22 of probe 20 is made of metal, e.g., stainless steel. The torque tube 40 resides within a guide tube (or inner lumen) 50 and is free to rotate and axially translate therein, though there is typically some contact between the torque tube and the guide tube, i.e., there is a close-fit between the torque tube and the guide tube. The torque tube 40 has a constant diameter and thus represents a configuration that presents a maximum amount of surface area to guide tube 50, i.e., that can contact the guide tube.

The guide tube 50 is transparent to an OCT imaging wavelength of light 60 at least at probe-end portion 22. In an example, a (transparent) balloon (not shown) is used to create space for probe-end portion 22 within tissue or vessel 70. The probe-end portion 22 of OCT system 10 is inserted into a catheter or endoscope (not shown) for insertion into the body to be examined.

The light 60 originates from a light source (not shown) and travels down optical fiber 30 to end 32. This light 60 exits end 32 of optical fiber 30 and is directed by probe 20 to the surrounding tissue or vessel 70. The light 60 generates scattered light 60S from tissue or vessel 70, and some of this scattered light returns to and is captured by probe 20 and directed back to optical fiber end 32. The returned scattered light 60S travels back down optical fiber 30 toward the light source and is then interferometrically processed to generate the OCT image at the OCT imaging wavelength according to methods known in the art.

As noted above, this configuration based on the use of torque tube 40 and guide tube 50 is relatively complicated and produces frictional forces between the torque tube and the guide tube that adversely affect the operation of OCT system 10.

### Integrated Torque Assembly

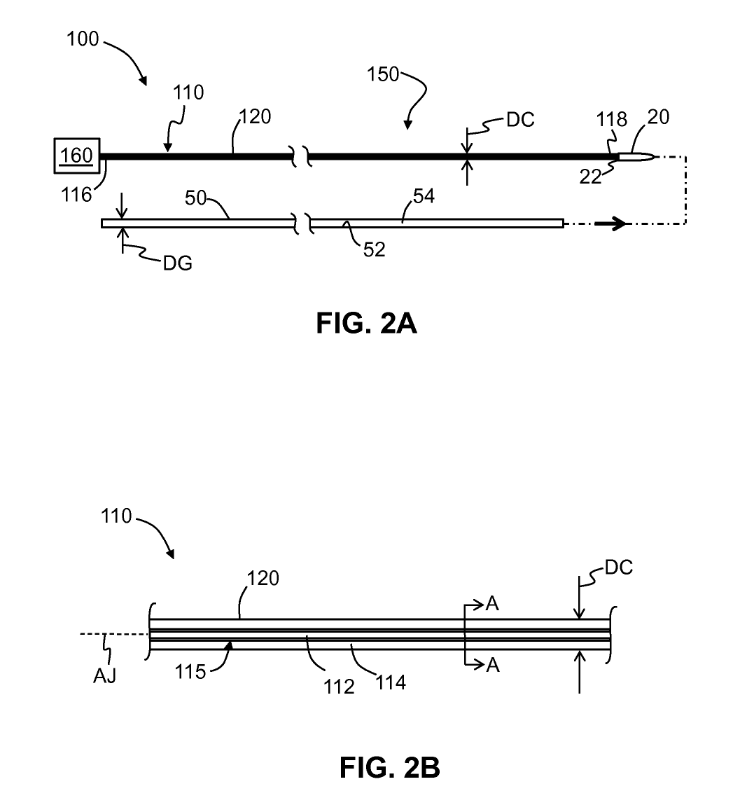

FIG. 2A is a partially exploded side view of a first example embodiment of an example OCT system 100 that includes an optical fiber cable (“cable”) 110 that along with probe 20 attached thereto and guide tube 50 defines an integrated torque assembly 150 according to the disclosure and as described below. The guide tube 50 includes an inner surface 52 that defines an interior 54 and an inner diameter DG.

FIG. 2B is a close-up cross-sectional view of a portion of an example cable 110. The cable 110 includes an optical fiber 112 and an outer jacket (“jacket”) 114 that surrounds the optical fiber. The optical fiber 112 can be a single-mode fiber or a multimode fiber. The cable 110 can also be referred to as a “jacketed optical fiber.” In an example, cable 110 is tightly buffered, i.e., is a tight-buffered cable. The jacket 114 includes an outer surface 120. Example materials for jacket 114 include PVC, thermoplastic elastomer (e.g., HYTREL), polyethylene, nylon, polymers, etc. The jacket 114 includes a central axis AJ. In an example, jacket 114 includes an axial bore 115 in which optical fiber 112 resides. In an example, axial bore 115 is centered on central axis AJ of jacket 114. In an example, axial bore 115 is defined by the process of integrally forming cable 110 from optical fiber 112 and jacket 114.

The cable 110 includes a proximal end 116 that is operably connected to a rotary and axial translation actuator (“actuator”) 160 and a distal end 118 that is operably connected to back-end portion 22 of probe 20.

### Example Cross-Sectional Shapes

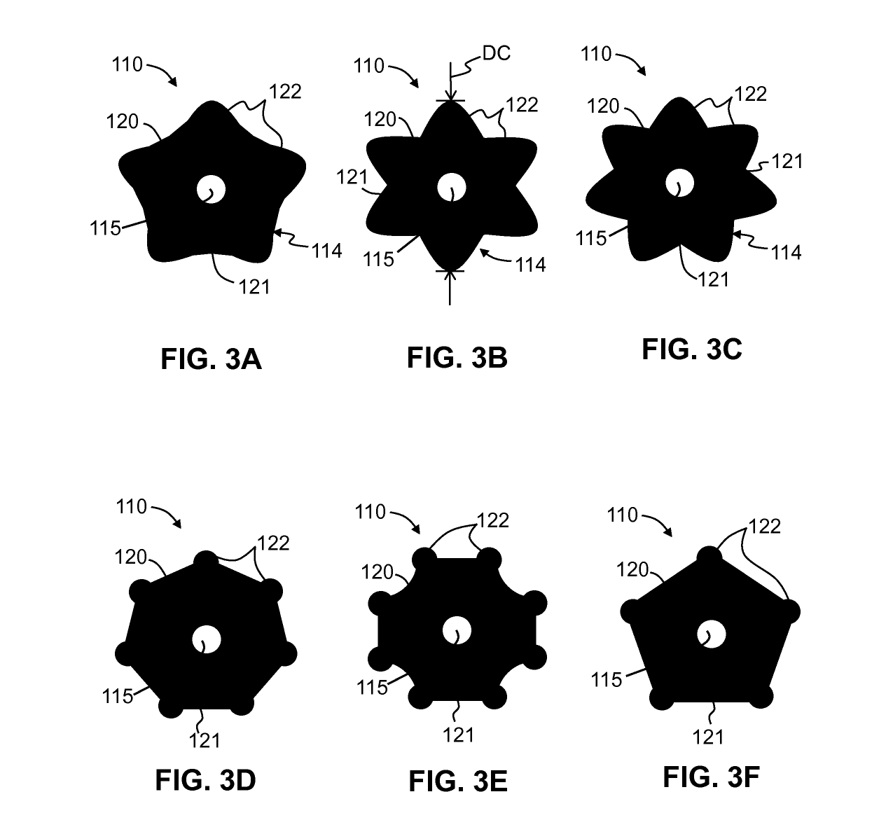

FIGS. 3A through 3L are cross-sectional views of jacket 114 as taken in the direction indicated by the arrows A-A in FIG. 2B, with the cross-sections showing different example embodiments of cross-sectional shapes of the jacket. The jacket 114 is configured to have a cross-sectional shape that presents a reduced amount of outer surface 120 to inner surface 52 of guide tube 50 as compared to a jacket having a circular cross-section. In other words, jacket 114 has a reduced amount of surface area available to contact inner surface 52 of guide tube 50 as compared to a jacket having a circular cross-section, for which the entire outer surface 120 can contact the guide tube inner surface.

In an example, jacket 114 can be considered as including a main body 121 and a plurality of protrusions 122 that outwardly extend from the main body. In an example, protrusions 122 outwardly (e.g., radially) extend with respect to jacket central axis AJ. In examples of jacket 114, protrusions 122 are rounded. In other examples of jacket 114, protrusions 122 have partial circular cross-sections. In the example of jacket 114 as shown in FIG. 3L, protrusions 122 are defined by the rounding of the corners of an otherwise square cross-sectional shape, with the white dotted line delineating the transition between circular main body 121 and the four corner protrusions 122.

In an example, jacket 114 includes an integer number N of protrusions 122, wherein in one example 3≦N≦10, while in another example 4≦N≦8. In an example, protrusions 122 run the entire axial length of cable 110.

An example jacket 114, such as shown in FIG. 31, includes one or more axial strength members 124 that run the length of the jacket at a location that is laterally offset from jacket central axis AJ. In one example, the one or more strength members 124 are formed from metal (e.g., metal wires), while in other examples they are formed from rods made of polymer or fiberglass or glass fiber reinforced plastic (GFRP). In an example, axial strength members 124 reside within protrusions 122, while in another example they reside within main body 121.

The cable 110 has a maximum lateral dimension DC similar to the diameter of a cable having a circular cross-section (see FIG. 3B). The maximum lateral dimension DC is thus referred to herein as the “cable diameter” even though the cross-sectional shape is not truly circular. In an example, cable diameter DC is in the range 500 μm≦DC≦1,500 μm.

The cable 110 can be formed using processes that are known in the art. In particular, cable 110 can be formed using a manufacturing operation that simultaneously forms optical fiber 112 and jacket 114, i.e., a drawing operation that forms the optical fiber and a coating operation that forms the jacket on the optical fiber. In an example, jacket 114 is formed from a single dielectric material. In an example embodiment, the formation of jacket 114 includes an extrusion process that employs an extrusion die having the desired cross-sectional shape. In an example, the extrusion process takes into account changes in the shape and size of jacket 114 after extrusion, e.g., contraction due to cooling of the jacket material.

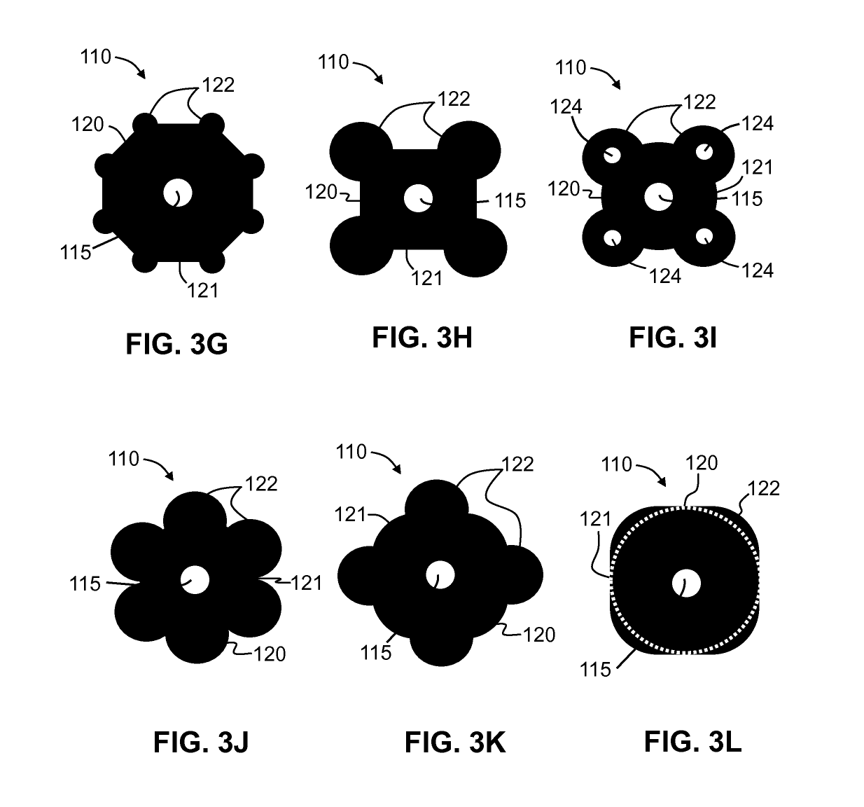

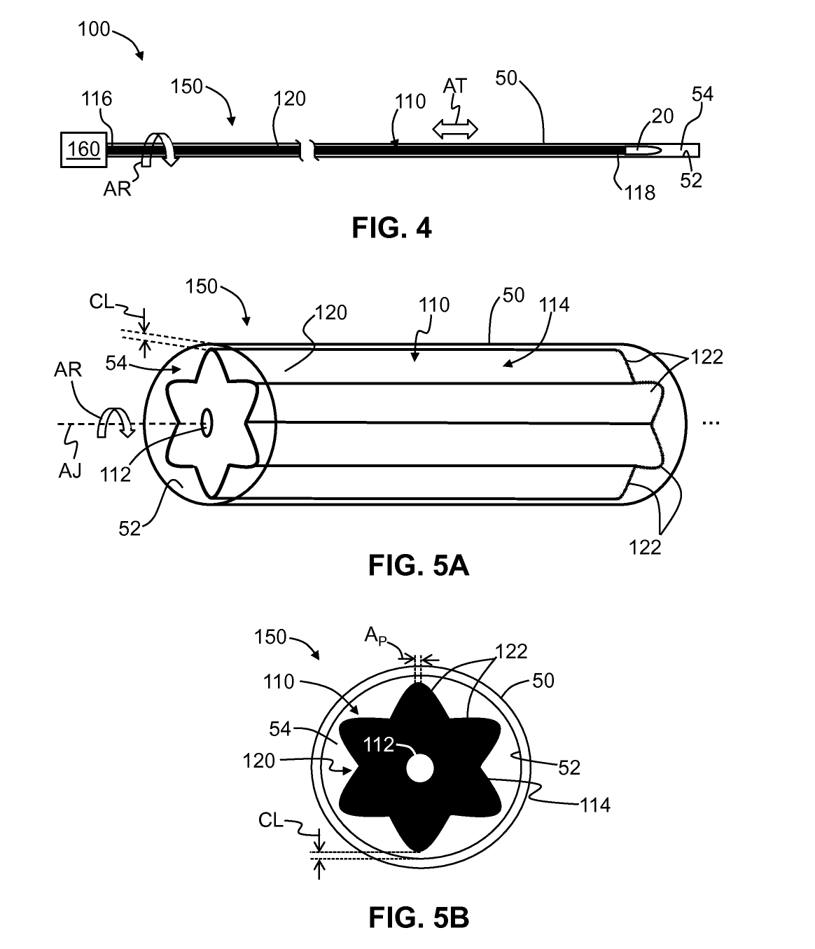

FIG. 4 is similar to FIG. 2A and shows the assembled OCT system with cable 110, probe 20 being attached to distal end 118, operably disposed within interior 54 of guide tube 50 in the close-fit configuration. FIG. 5A is a close-up front-elevated cut-away view of an example cable 110 with its jacket 114 having the cross-sectional shape of FIG. 3B by way of example. FIG. 5B is a front-on view of integrated torque assembly 150 of FIG. 5A. The cable 110 is operably arranged within interior 54 of guide tube 50 to define integrated torque assembly 150. An arrow AR shows the rotation of cable 110 while a double arrow AT shows the axial translation directions of the cable.

As noted above, guide tube 50 has inner surface 52, which defines interior 54 as having a generally circular cross-section and inner diameter DG. The cable diameter DC, as defined by the one or more protrusions 122, is slightly smaller than inner diameter DG of guide tube 50 so that cable 110 defines a close fit within interior 54 of the guide tube. The combination of guide tube 50 and cable 110 operably disposed within guide tube interior 54 defines integrated torque assembly 150.

The clearance CL=(DG−DC) of cable 110 within guide tube 50 (see FIGS. 5A and 5B) is selected to represent a balance between preventing uncontrolled lateral movement (“lashing”) of cable 110 during rotation AR and axial translation AT of the cable within guide tube interior 54, including when the guide tube is bent or flexed during an OCT procedure. Thus, cable 110 and interior 54 of guide tube 50 define a close fit, i.e., one in which there is sufficient space for the cable to rotate and axially translate within the guide tube interior but insufficient space for the cable to be laterally displaced to a substantial extent, e.g., no more than a few percent of the cable diameter DC.

Thus, in the close-fit configuration, cable 110 is loosely arranged within interior 54 of guide tube 50 with only protrusions 122 being able to come into contact with inner surface 52 of the guide tube. The amount of area presented by protrusions 122 to inner surface 52 of guide tube 50 is substantially less than for the prior-art torque tube 40 discussed above, which has circular cross-sectional shape. Thus, protrusions 122 can be thought of as stand-off features that prevent the entire outer surface 120 of jacket 114 from being able to make contact with inner surface 52 of guide tube 50. This configuration serves to reduce the amount of friction that can occur between cable 110 and guide tube 50 during rotation and axial translation of the cable during an OCT procedure.

In an example, the outermost portions of protrusions 122 are rounded. In an example, protrusions 122 are configured to allow for only a relatively small portion of outer surface 120 of jacket 114 to contact inner surface 52 of guide tube 50. Another way to state this condition is that a relatively small area defined by inner surface 52 of guide tube 50 is subject to contact by jacket 114. This is best illustrated in the front-on view of integrated torque assembly 150 of FIG. 5B, which schematically illustrates a protrusion contact “area” A_{P} for one of the protrusions 122 of jacket 114, which in the example shown includes six protrusions. Here, because of the axial symmetry, the “area” is actually represented as a linear measure for ease of illustration and without loss of accuracy.

The total protrusion contact area A_{T} for the example integrated torque assembly 150 of FIG. 5B would be A_{T}=6·(A_{P}). A contact-area ratio RC can be defined as RC=A_{T}/CIR, where CIR is the total circumference of inner surface 52 of guide tube 50 and A_{T} is the aforementioned total possible contact area that jacket outer surface 120 presents to the guide tube inner surface. By way of estimation, if A_{P} is about 1/50th of the total circumference CIR of inner surface 52 of guide tube 50, then the contact-area ratio RC=A_{T}/CIR=6/50=0.12 or 12%. For a protrusion contact area A_{Pb =1/100}, RC=A_{T}/CIR=6/100=6%. For an example cable 110 that includes four protrusions 122, RC=A_{T}/CIR=4/100=4%.

The amount of total protrusion contact area A_{T} will depend on a number of factors, such as the number of protrusions 122, the size of the protrusions, the hardness of the material making up jacket 114, the hardness of guide tube 50, the amount of force with which cable 110 contacts inner surface 52 of the guide tube, etc. In various examples of integrated torque assembly 150, the contact-area ratio RC≦50%, or RC≦25%, or RC≦20%, or RC≦10%, or RC≦5%, or RC≦2% or RC≦1%.

Random manufacturing variations in guide tube 50 and cable 110 can cause an increase in the frictional forces or an increase in the lashing of the cable within the guide tube. These variations can lead to non-uniform rotation of probe 20 and can put stress on the various components. This stress can lead to a failure of OCT system 100, e.g., probe 20 becoming disconnected from cable 110. Thus, in an example, the clearance CL=(DG−DC) is in the range from 100 μm to 150 μm to define the close-fit configuration and to reduce or minimize the adverse effects of the random manufacturing variations.

In an example, guide tube 50 can be formed using an extrusion or a drawing process. The extrusion process provides good dimensional control, thereby reducing the potential adverse effects of the aforementioned random manufacturing errors.

### Low-Friction Coating

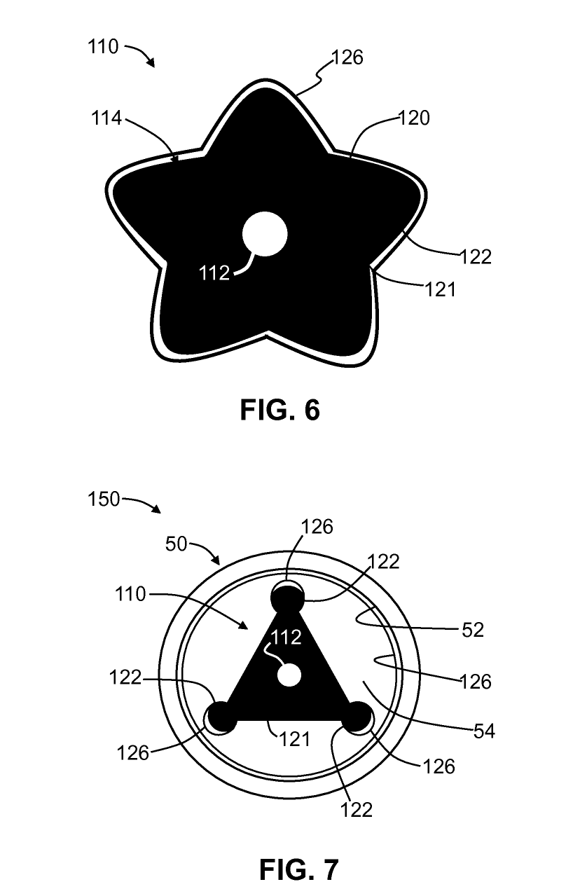

In an example embodiment, one or more components of OCT system 100 can include a low-friction coating. FIG. 6 is a close-up cross-sectional view of an example cable 110 and jacket 114 wherein outer surface 120 includes a low-friction coating 126. The low-friction coating 126 facilitates the low-friction rotation AR and axial translation AT of cable 110 within interior 54 of guide tube 50. In an example, at least the outermost portion of protrusions 122 that make contact with inner surface 52 of guide tube 50 includes low-friction coating 126.

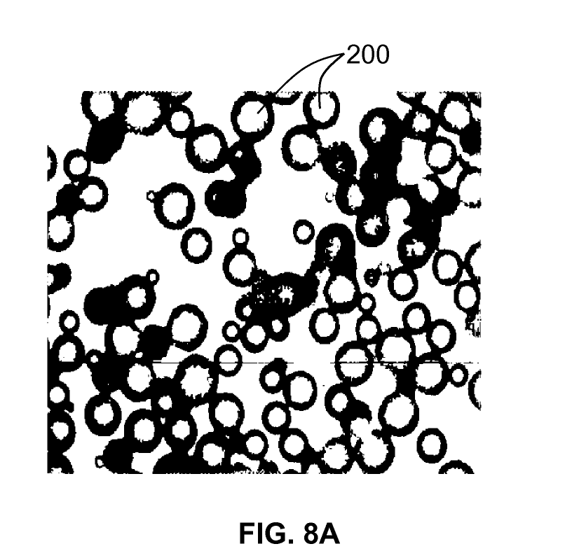

FIG. 7 is a cross-sectional view of an example integrated torque assembly 150 wherein jacket 114 has a triangular cross-sectional shape that defines three protrusions 122, and wherein guide tube 50 includes low-friction coating 126 on inner surface 52. FIG. 7 also shows the outermost portions of protrusions 122 as including respective low-friction coatings 126. In another example one or the other of protrusions 122 and inner surface 52 of guide tube 50 includes low-friction coating 126.

Example low-friction materials include polytetrafluorotethylene, polyimide, polyamide, polyethylene, polysilicone, fluorosilane, fluoroether silanes, silicones, etc. In an example, jacket outer surface 120 (or low-friction coating 126 thereon) has a coefficient of static friction μ_{S}<0.5, while in another example, μ_{S}<0.1, while yet in another example, μ_{S}<0.05. In an example, low-friction coating 126 is defined as having a static coefficient of friction that is less than that of the surface to which the coating is applied.

The low-friction coating 126 can be made from any of the known low-friction materials and can be spray coated, spin coated, dipped coated, etc. In one example, a TEFLON-based low-friction coating 126 was prepared using 1% TEFLON AF in a fluoroether solvent FC-40 and combined with a solution of adhesion binder (1 wt % in HFE7200) to produce a solution that was 1 wt % total in polymer mass. The solution was filtered through a coarse paper filter prior to use. An example of using an adhesion binder and the preparation details for non-stick coating materials are described in U.S. Patent Application Publication No. 2012/0189843.

In another example, low-friction coating 126 can be made from heptadecafluoro-tetrahyd rodecyl-trichlorosilane (C₁₀H₄F₁₇Si Cl₃) by combining perfluorosilane with anhydrous heptane. The metal surfaces can then be cleaned and then immersed in the coating solution for 1 minute. Upon removal, the coated metal surfaces can be rinsed with heptane and then ethanol.

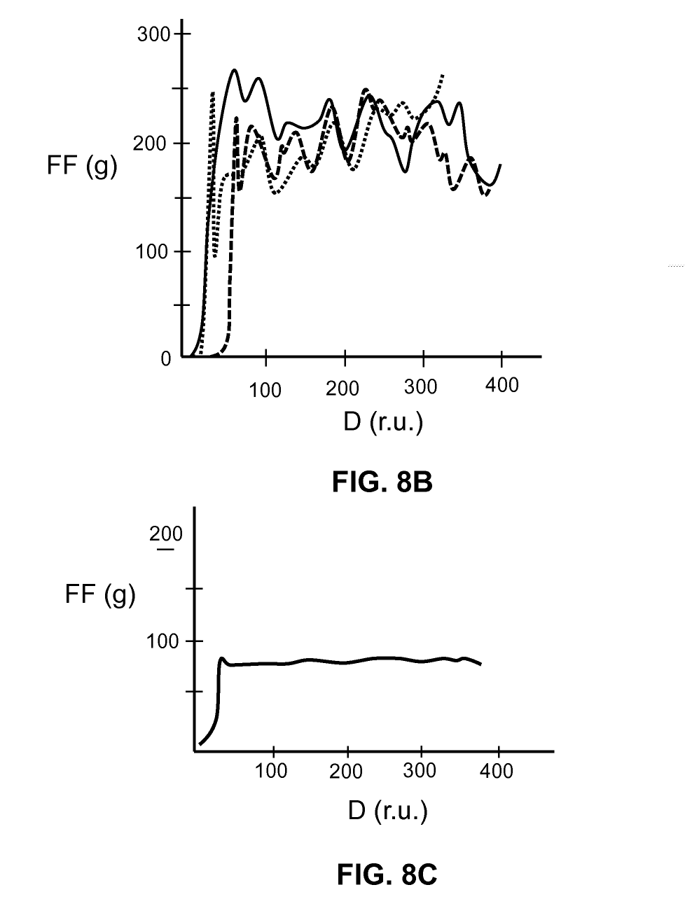

In an example, low-friction coating 126 includes one or more low-friction enhancements, such as low-friction particles and/or additives. The particles and/or additives can also be added to inner surface 52 of guide tube 50 and/or jacket 114 of cable 110 during their fabrication. FIG. 8A is photograph of TexMatte material 6025 having PMMA particles 200 having a size in the range from 25 μm to 30 μm.

FIG. 8B is a plot of the friction force FF (grams, g) versus distance D (relative units, r.u.) for white ink as a control material. The plot is based on three sets of measurements obtained using a conventional frictional force measurement device.

FIG. 8C is the same plot as FIG. 8B but for the case wherein the white-ink material is coated with low-friction coating 126 of TexMatte 6025 beads with 20% F-acrylate low-friction additive. The plot of FIG. 8C is based on an average of three sets of measurements and shows that the addition of the beads and the low-friction additive substantially reduces the coefficient of friction of the control material.

### Method of Performing OCT

An aspect of the disclosure is a method of performing OCT by rotating and axially translating optical probe 20 in OCT system 100. The method includes providing cable 110, with optical probe 20 being operably connected to the cable at distal end 118. The cable 110 has a cross-sectional shape that includes a plurality of protrusions 122 that outwardly extend from main body 121. The protrusions 122 are configured to reduce the contact-area ratio RC as compared to a cable 110 having a circular cross-section.

The cable 110 and probe 20 are then inserted into interior 54 of flexible guide tube 50 in a close-fitting configuration to define integrated torque assembly 150. The method further includes causing a rotation and an axial translation of cable 110 at its proximal end 116, e.g., by activating actuator 160 operably connected thereto. This causes the rotation and axial translation of cable 110 and optical probe 20 attached thereto within interior 54 of flexible guide tube 50. The cable 110 transfers the torque and axial translation generated by actuator 160 at proximal end 116 of cable 110 to distal end 118, thereby causing the rotation and axial translation of optical probe 20. Only the outermost portions of protrusions 122 make contact with inner surface 52 of guide tube 50 during the rotation and axial translation of cable 110 and the transfer of the torque from cable proximal end 116 to cable distal end 118 and probe 20. In examples of the method, one or more low-friction coatings 126 are employed on at least one of: inner surface 52 of guide tube 50 and protrusions 122 of cable 110.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. An integrated torque assembly for use with a guide tube of an optical coherence tomography (OCT) system that utilizes a rotating optical probe, comprising:
a flexible guide tube having an inside surface that defines a guide tube inner diameter and a guide tube interior, with at least a portion of the guide tube being transparent to light at an OCT imaging wavelength;
an optical fiber cable having an optical fiber surrounded by a jacket and having a length, the optical fiber cable having a proximal end and a distal end, wherein the jacket has a plurality of outwardly extending protrusions;
an optical probe operably connected to the distal end of the optical fiber cable; and
wherein the optical fiber cable and optical probe are operably disposed within the guide-tube interior in a close-fit configuration wherein the optical fiber cable can rotate and be axially translated within the interior of the flexible guide tube while the optical fiber cable only contacts the inner surface of the guide tube at the protrusions of the jacket.

2. The integrated torque assembly according to claim 1, wherein the optical fiber cable has a diameter DC, the guide tube has an inner diameter DG, and wherein the optical fiber cable and guide tube define a clearance CL=(DG−DC) in the range from 100 μm to 150 μm.

3. The integrated torque assembly according to claim 1, wherein at least one of the jacket of the optical-fiber cable and the inner surface of the guide tube include a low-friction coating.

4. The integrated torque assembly according to claim 3, wherein the low-friction coating has a static coefficient of friction μ_{S}≦0.1.

5. The integrated torque assembly according to claim 4, wherein the low-friction coating includes a material selected from the group of materials comprising:
polytetrafluorotethylenes, TEFLON AF, polyimides, polyamides, polyethylenes, polysilicones, fluorosilanes, fluoroether silanes, and silicones.

6. The integrated torque assembly according to claim 1, wherein the optical-fiber cable is tightly buffered.

7. The integrated torque assembly according to claim 1, wherein the jacket includes a number N of the protrusions, wherein 3≦N≦10.

8. The integrated torque assembly according to claim 1, wherein each of the protrusions includes a partial circular cross-section.

9. An optical coherence tomography (OCT) assembly, comprising:
the integrated torque assembly of claim 1; and
a rotary and axial translation actuator operably attached to the proximal end of the optical fiber cable.

10. An integrated torque assembly for use with a guide tube of an optical coherence tomography (OCT) system that utilizes a rotating optical probe, comprising:
a flexible and transparent guide tube having an inside surface that defines a guide-tube inner diameter and a guide-tube interior;
an optical fiber cable having an optical fiber having a proximal end and a distal end, and having a jacket that includes a main body and a plurality of protrusions that outwardly extend from the main body, with the protrusions and the inner surface of the guide tube defining a contact-area ratio RC 50%;
an optical probe operably connected to the distal end of the optical fiber cable; and
wherein the optical fiber cable and optical probe are operably disposed within the guide-tube interior in a close-fit configuration such that the optical fiber cable can rotate and be axially translated within the interior of the flexible guide tube.

11. The integrated torque assembly according to claim 10, wherein the contact-area ratio RC≦10%.

12. The integrated torque assembly according to claim 10, wherein the contact-area ratio RC≦1%.

13. The integrated torque assembly according to claim 10, wherein the optical fiber cable has a diameter DC, the guide tube has an inner diameter DG, and wherein the optical fiber cable and guide tube define a clearance CL=(DG−DC) in the range from 100 μm to 150 μm.

14. An optical coherence tomography (OCT) assembly, comprising:
the integrated torque assembly of claim 10; and
a rotary and axial translation actuator operably attached to the proximal end of the optical-fiber cable.

15. A method of rotating and axially translating an optical probe in an optical coherence tomography (OCT) system, comprising:
operably connecting an optical probe to a distal end of an optical fiber cable having a proximal end and an outer jacket with a main body and a plurality of outwardly extending protrusions each having an outermost portion;
inserting the optical fiber cable and probe into an interior of a flexible guide tube having an inner surface to define a close-fit configuration between the optical fiber cable and the guide tube; and
causing a rotation and an axial translation of the optical fiber cable at the proximal end so that the optical fiber cable and optical probe rotate and axially translate within the interior of the flexible guide tube while the optical fiber cable only contacts the inner surface of the guide tube at the outermost portions of the protrusions of the jacket.

16. The method according to claim 15, wherein the close-fit configuration is defined by a clearance between the outermost portions of the protrusions and an inner surface of the flexible guide tube of between 100 μm and 150 μm.

17. The method according to claim 16, wherein the causing of the rotation and axial translation of the optical-fiber cable at its proximal end includes operably connecting the proximal end of the optical-fiber cable to a rotary and axial-translation actuator and activating the rotary and axial-translation actuator.

18. The method according to claim 15, wherein at least one of an inner surface of the guide tube and the outermost portions of the protrusions includes a low-friction coating having a coefficient of static friction μ_{S}≦0.1.

19. The method according to claim 18, wherein the low-friction coating includes at least one of a low-friction additive and low-friction beads.

20. The method according to claim 15, wherein the optical fiber cable has a maximum lateral dimension in the range from 500 μm to 1,500 μm.
